(19) United States
(12) Patent Application Publication
(10) Pub. No.: US 2007/0008099 A1
(43) Pub. Date: Jan. 11, 2007

(54) Method and apparatus for remotely monitoring a site

(75) Inventors: David E. Kimmel, Fredericksburg, VA (US); Donald R. Jones, New Canton, VA (US); Ronald Dubois, Dumfries, VA (US); Daniel C. Colin, Montgomery, TX (US)

Correspondence Address: COVINGTON & BURLING, LLP;ATTN: PATENT DOCKETING, 1201 PENNSYLVANIA AVENUE, N.W., WASHINGTON, DC, 20004-2401, US

(73) Assignee: NetTalon Security Systems, Inc., Fredericksburg, VA (US)

(21) Appl. No.: 11/433,757

(22) Filed: May 15, 2006

Related U.S. Application Data
(63) Continuation-in-part of application No. 11/140,925, filed on Jun. 1, 2005, now abandoned.
Application No. 11/140,925 is a continuation of application No. 10/140,439, filed on May 8, 2002, now Pat. No. 6,917,288.
Application No. 10/140,439 is a continuation-in-part of application No. 10/069,788, filed on Feb. 28, 2002, now Pat. No. 6,972,676.
Application No. 10/069,788 is a continuation of application No. 09/387,496, filed on Sep. 1, 1999, now Pat. No. 6,281,790.

(51) Int. Cl. G08B 29/00

(52) U.S. Cl. 340/506

(57) ABSTRACT

The present invention is directed to providing systems and methods for remotely monitoring sites to provide real-time information which can readily permit distinguishing false alarms, and which can identify and track the precise location of an alarm. In embodiments, monitoring capabilities such as intrusion/fire detection and tracking capabilities, can be implemented through the use of multistate indicators in an interface which permits information to be transmitted using standard network protocols from a remote site to a monitoring station in near real-time. In embodiments, communications can be handed from the centrally located host monitoring station to a mobile monitoring station (for example, a laptop computer in a responding vehicle, such as a police or fire vehicle). Additional embodiments include the measurement of environmental parameters such as temperature, carbon monoxide and differential air pressure to detect, monitor and manage a fire event. These measurements along with selected controllable output devices deployed in a space, such as sprinkler control valves and individually or zoned sprinkler heads, are used to initiate and control fire suppression technology both locally and remotely. For instance, a system of the present invention may detect a fire and cause a sprinkler system to disburse water in a facility.

### CROSS-REFERENCE TO RELATED APPLICATIONS

This application is a continuation-in-part of U.S. application Ser. No. 11/140,925, filed Jun. 1, 2005, now U.S. Pat. No. 6,917,288, which is a continuation of U.S. application Ser. No. 10/140,439, which is a continuation-in-part of U.S. application Ser. No. 10/069,788, filed Feb. 28, 2002, now U.S. Pat. No. 6,972,676, which was filed as a United States national stage application under 35 U.S.C. § 371 of Patent Cooperation Treaty application serial number PCT/US00/23974, filed Sep. 1, 2000, which claims priority under 35 U.S.C. § 119 to U.S. application Ser. No. 09/387,496, filed Sep. 1, 1999, now U.S. Pat. No. 6,281,790. Each of the above-identified applications and patents is incorporated herein by reference in its entirety.

### FIELD OF THE INVENTION

The present invention relates generally to monitoring a remote site. More particularly, the present invention is directed to monitoring a remote site by providing real-time or substantially real time transmission of outputs from a plurality of digital and/or analog multistate sensors which detect intrusion, fire, environmental or other parameters, and communicate this information in an efficient and effective format. This information may, for example, describe the nature of an evolving emergency.

### BACKGROUND OF THE INVENTION

Existing intrusion detection systems and their respective monitoring stations typically provide binary off/on alert information to the user. Known security systems employ binary status detection devices due to the availability and low cost of these devices, and report only active (versus inactive) alarm status information. For example, an indicator, such as a lamp or audible output, may be on when a particular sensor is tripped, and may be “off” when the sensor is reset. Some known methods capture dynamic point state transitions using, for example, latching sensors that hold a transition state for a limited period of time and then reset automatically.

Systems that offer more detailed information typically resort to specialized communication protocols and proprietary interconnection solutions. For example, monitoring systems for property protection and surveillance are known which transmit live audio and/or video data. However, a large number of video surveillance cameras is cost prohibitive, and they generate large quantities of data that cannot be easily transmitted to remote monitoring sites in real-time. Accordingly, these systems have not achieved the widespread use associated with binary off/on systems.

Systems that supply binary off/on alert information, even sophisticated systems that employ multiple sensors in a monitored space, typically only resolve alert information to a particular sector, or zone, of the building or space under surveillance. Thus, for example, information such as the precise location of a potential intruder is not provided to responding police officers. Even when a large number of sensors is used to increase the resolution of alert information, the use of binary on/off indicators prohibits any meaningful ability to track an intruder's movement through the building and yet still be able to resolve the current location of the intruder.

In addition, known binary off/on systems typically cannot distinguish whether an alarm is real (i.e., genuine) or false. When police arrive on the scene of a building where an alarm was tripped, they do not know whether the alarm is real or false, and they have little or no information about what is inside the building. Substantial time and money is wasted when police respond to large numbers of false alarms. Even when the alarms are valid, police often expect another false alarm and can be taken by surprise. They also may enter the building not knowing where the subject(s) might be.

The same drawbacks exist for known fire monitoring and surveillance systems. The false/real alarm distinction, exact location of the fire, and the movement of the fire are unknown to the fire company which receives and responds to the alarm. In addition, existing fire monitoring and surveillance systems do not provide real-time information to the first responders that would otherwise enable them to initiate life safety procedures under conditions of more nearly complete information.

Accordingly, it would be desirable to provide a system and method for monitoring a remote site, whereby the false/real alarms can be accurately distinguished, and whereby movement of intruders or fire, or changes in an environmental or other parameter, can be reliably tracked while precisely locating the intruder, fire, or other cause of parameter change. It would also be desirable to provide this information, in real-time, to monitoring sites for use by responding personnel.

### SUMMARY OF THE INVENTION

The present invention is directed to providing systems and methods for remotely monitoring sites to provide real-time information that can readily distinguish false alarms from real ones and that can identify and track the location of an alarm and/or its cause with substantial precision. In exemplary embodiments, monitoring capabilities such as intrusion/fire detection and tracking capabilities can be implemented through the use of multistate indicators in a novel interface that permits information to be transmitted using standard network protocols from a remote site to a monitoring station in real-time over preexisting communication network transmission pathways (e.g. wire, fiber optic, wireless and satellite). Communications can thereby be established between a centrally located host monitoring station and a separate security/fire panel deployed in each of the buildings to be remotely monitored.

An embodiment of the present invention provides a system for monitoring a space, with a sensor configured to monitor a parameter. A security/fire panel located at the space is configured to receive information from the sensor regarding a value of the parameter. The security/fire panel is also configured to identify a first alarm state, such as a high or low alarm state, from the parameter value information. The security/fire panel is also configured to initiate fire suppression in response to the alarm state.

In some embodiments, a high alarm state may be identified when the value of the parameter exceeds either a predetermined high-end threshold or a predetermined rate-of-change threshold. A low alarm state may be identified when the value of the parameter is less than a predetermined low-end threshold. The security/fire panel may enable or disable a fire suppression system based on sensor information and/or the alarm state, e.g., by actuating or de-actuating a fire suppression device such as a sprinkler control valve, which may be located near the sensor. The security/fire panel may also alert a local or remote operator of an alarm state, for example, so that the operator can locally or remotely enable or disable fire suppression. In some embodiments, the security/fire panel monitors the state of a sprinkler control valve or other component of the fire suppression system. In some embodiments, the security/fire panel automatically transmits alarm information to a monitoring station that may be remote from the space, for example, in response to the first alarm.

Embodiments of a system in accordance with the present invention may further comprise a graphical user interface. The graphical user interface may display an icon responsive to a state of the fire suppression system or one or more fire suppression system components. The graphical user interface may display an icon responsive to the first alarm state and/or a value of the parameter.

In some embodiments, the information received from the sensor comprises a self-initiated notification signal indicating a change of the value of a parameter measured by at least one of the plurality of sensors. The information may be received at substantially the same time the change is measured. In some embodiments, temperature is displayed as an icon, and the color of the icon may indicate the value of the temperature and/or the state of a corresponding temperature sensor.

Another embodiment of the present invention provides a system for monitoring a space having a plurality of sensors. Each of the plurality of sensors located at a predetermined monitoring location. A monitoring system is configured to receive a substantially real-time self-initiated notification signal indicating a change of a value of a parameter measured by at least one of the plurality of sensors. Based on the notification signal, a graphic interface is configured to display the value of the parameter measured by the at least one of the plurality of sensors. In embodiments, the graphical user interface displays a state of fire suppression activity within an area associated with an alarm responsive to the change of the parameter value and a state of a fire suppression actuator in the area.

Another embodiment of the present invention provides a system for monitoring a space. A sensor is configured to monitor a parameter associated with the space. A security/fire panel located at the space is configured to receive information about a value of the parameter from the sensor. The security/fire panel identifies a high alarm state from the parameter value information when the value of the parameter exceeds either a predetermined high-end threshold or rate of rise threshold. The security/fire panel initiates fire suppression responsive to the high alarm state. The security/fire panel identifies a low alarm state from the parameter value information when the value of the parameter is lower than a predetermined low-end threshold. Responsive to the low alarm state, the security/fire panel disables fire suppression. In embodiments, the security/fire panel alerts an operator to enable or disable fire suppression responsive to a high or low alarm state. The security/fire panel may also monitor the state of a fire suppression shut-off valve. The security/fire panel may further automatically transmit low alarm state information and high alarm state information to a monitoring station.

The term “security/fire panel,” as used in this specification, includes a wide variety of security/fire panels that are in communication with sensors, and that are capable of providing information to a monitoring system. “Security/fire panels” may include, but are not limited to, panels for monitoring security information (intruders, broken windows, and the like), fire or temperature information, the presence of chemicals or other contaminants in the air, acidity, alkalinity, water pressure, air pressure, wind velocity, magnitude of force, signal integrity, bit error rate, voltage, current, resistance, location of various physical objects, motion, vibration, sound, light, magnetic field, and any other parameters (or changes in parameters) that are measurable by sensors or capable of being determined or identified by processors that process sensor information. In exemplary embodiments, communications can be transmitted from a centrally located host monitoring system to a mobile monitoring station (for example, to a laptop computer in a responding vehicle, such as a police or fire vehicle). The transmission can be such that direct communications are established between a security/fire panel located at a site being monitored and the mobile monitoring station (for example, via communication with a laptop over a wireless network). Alternatively or in addition, indirect communications can be established via the host monitoring station.

The term “parameter” is meant broadly to encompass a wide range of parameters that can be measured by a sensor. Parameters include, but are not limited to, temperature, concentration of various chemicals (such as combustible gases) in the air or elsewhere, water pressure, wind velocity, magnitude of force, a measure of signal integrity or bit error rates in communications transmissions facilities such as fiber-optic cables, geometric position of various mechanical devices such as valves and any other parameter, such as those parameters mentioned herein, that may be measured such that a state or change in state of the parameter may be determined. The term “parameter” may also include, as a further example, the state of a fire suppression system or system component, such as a sprinkler control valve or shut-off actuator.

Embodiments of the present invention can provide primary visual alarm status reporting that gives the monitoring authority (e.g., a user) the ability to identify the precise location of an intrusion and/or fire, and to distinguish false alarms from real ones. Multiple state, or multistate, indications are provided to represent a sensor. For example, in various embodiments, each sensor may be identified as being: (1) currently in alarm; (2) currently in alarm and acknowledged by a monitor; (3) recently in alarm; (4) not in alarm; (5) disabled; or (6) non-reporting. With these multistate indications, the movements of an intruder or fire can be tracked, and yet the location of the intruder/fire can still be identified with a great deal of precision. This additional tracking ability gives police and firemen a tactical advantage at the scene as they know the location of the subject/fire and can track any subsequent movements as they close in order to make an arrest and/or fight the fire.

In additional embodiments, multiple alarm states may be provided. Alarm states may include, for example, a high alarm state, a rate of change alarm state, a low alarm state, an early warning of possible coming alarm, and a default not-in-alarm state. Each state may be represented by an icon at a monitoring station. Each icon state may be represented by a color or shape indicative of (or otherwise associated with) the current state of the sensor.

In another embodiment, a representation of an entire space may be provided based on information derived from the sensor states of controlling sensors. This may provide a user with information useful for tracking the evolution of a change within the monitored space. For instance, information may be derived from a state of one or more fire suppression actuators. The fire suppression actuators may be selectively and automatically controllable, and they may include actuators such as sprinkler control valves and individually or zoned sprinkler heads, and sprinkler shut-off valves. Accordingly, information from one or more temperature, fire, and fire suppression control sensors may be used to identify and track the origin, spread, and extinguishing of a fire.

In still another embodiment, a representation of the entire space may be provided based on information derived from the state of one or more fire suppression shut-off valves. This provides further information to the user in tracking the alarm condition and whether the sprinkler control valves are currently enabled or disabled within the monitored space.

Exemplary embodiments of the present invention are directed to a method and apparatus for monitoring a space. A security/fire panel located at the space is associated with a plurality of sensors. A monitoring system receives real-time or substantially real-time information regarding the space from the security/fire panel over a network using a network protocol. The monitoring system includes a graphic interface to display said information as multistate outputs associated with each of the plurality of sensors.

In accordance with other embodiments, an apparatus is provided for monitoring a space. The apparatus comprises a security/fire panel located at the space. A monitoring system receives real-time or substantially real-time information regarding the space from the security/fire panel over a network. The monitoring system including a graphic interface to display information that distinguishes false alarms from actual alarms.

In other exemplary embodiments, updated information may be provided in real-time or substantially real-time regarding the status of sensors associated with point alarms in a monitored space. The graphical display of information can be provided as a hierarchical representation of network-to-site-to-point status using a plurality of tiered screen displays. The supervisory monitoring system can be configured as a central or distributed monitoring system including, but not limited to, the use of a central processor such as a base station host computer. The central processor may optionally direct information to the user, for example, via wired or wireless communication such as a cellular telephone network and/or paging service, for example, in real-time or substantially real-time. Alternate embodiments can also include security measures, such as the pseudo-randomizing of port access to a network to secure command and control communications.

### BRIEF DESCRIPTION OF THE DRAWINGS

Other objects and advantages of the present invention will become more apparent to those skilled in the art upon reading the detailed description, wherein like elements have been designated by like numerals, and wherein:

FIG. 1 shows an exemplary graphics screen viewed through a security/fire panel web page, wherein the graphics screen displays a floorplan layout, with special icons overlaid on a bitmap to identify sensor points and their status;

FIG. 2 shows a general overview of communications between four basic subsystems;

FIG. 3 shows basic components of an exemplary system block diagram;

FIG. 4 shows a detailed diagram of an exemplary host computer in a supervisory monitoring system;

FIG. 5 shows a detailed diagram of an exemplary remote computer;

FIG. 6 shows a detailed diagram of an exemplary security/fire panel;

FIG. 7 shows a detailed diagram of an exemplary mobile computer;

FIG. 8 shows an exemplary display screen;

FIG. 9 shows exemplary communications between the fire panel and the host computer;

FIG. 10 shows exemplary communications between the host computer and the remote computer;

FIG. 11 shows exemplary communications between the security/fire panel and the remote computer;

FIG. 12 shows exemplary communications between the security/fire panel and the mobile computer;

FIG. 13 shows an exemplary graphical depiction of an arrangement of temperature sensors and sprinkler control valves located at a space.

### DETAILED DESCRIPTION OF EXEMPLARY EMBODIMENTS

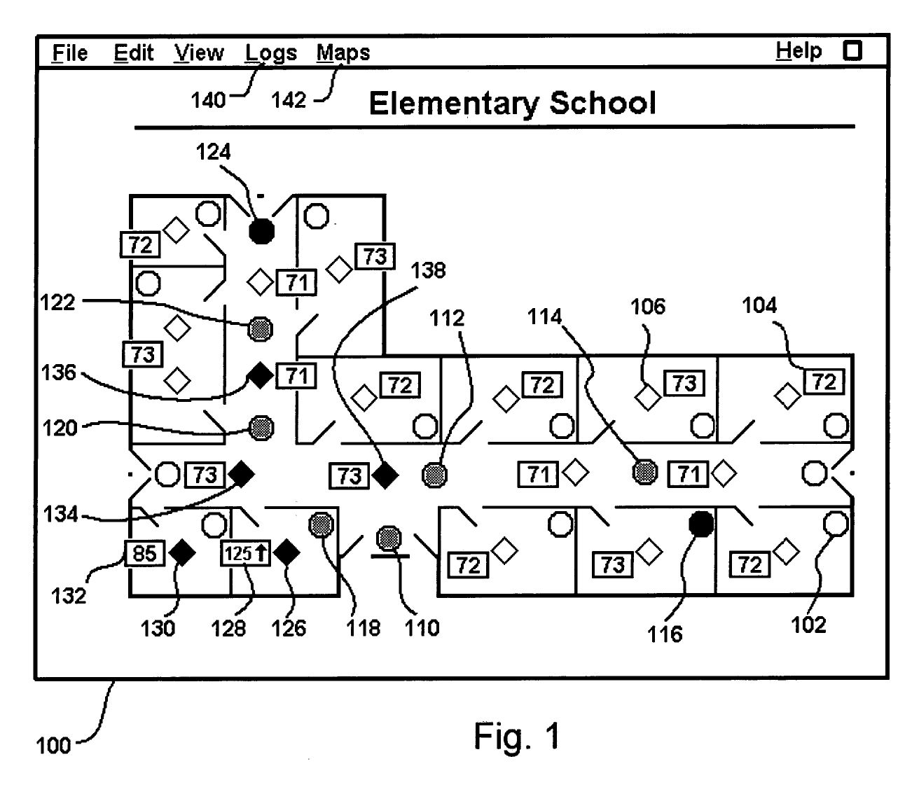

1. Functional Overview. Before describing details of an exemplary system for implementing an exemplary embodiment of the present invention, an overview of the invention will be provided using one exemplary display of information that is provided at a supervisory monitoring system's graphical user interface in accordance with the present invention. Referring to FIG. 1, a graphical user interface provides a screen display 100 of a particular floor plan in a building being monitored for intrusion and fire detection. In the FIG. 1 example, a graphical user interface included in the supervisory monitoring system is displaying a building floor plan for an elementary school with its alarm points, and illustrates a two-person intrusion with a related fire (arson) in progress. In this black/white rendition, points not in alarm are white circles 102 indicating intrusion detectors, environmental monitors 104 (in this example, air temperature) indicating reasonably expected room temperatures, and white diamonds 106 indicating fire detectors. Two black circles 116, 124 indicate two intrusion points that are in simultaneous alarm. The gray filled circles 110, 112, 114, 118, 120 and 122 show intrusion alarms in a latched condition; that is, they were recently in alarm but are not now in alarm. The five black diamonds 126, 130, 134, 136, and 138 indicate fire detectors that have entered an alarm state. The temperature sensor 128 indicates a “rate-of-rise” alarm, while the temperature sensor 132 is showing an abnormal higher than building average value.

Thus, at least three different states (for example, not in alarm; recently in alarm; and in alarm) are associated with the detector located at each alarm point in the FIG. 1 floorplan to provide a multistate indication for each alarm point at the user interface. Any number of states can be provided, such as additional states to represent inoperable or disabled alarm points. For example, as described below with respect to another exemplary embodiment, six such states can be used.

The user can apply pattern discrimination through visual representation of alarm point conditions provided by the display at a moment in or very short period of time, referenced herein as an “event slice,” to understand and convey the nature of the intrusion. By monitoring the display of alarm states, false alarms can be readily distinguished from genuine alarms (that is, actual intrusions and/or fires). For example, a mouse cursor associated with the supervisory monitoring system's graphical user interface can be positioned next to a particular alarm point icon to access additional alarm point information. This alarm point information can identify the type of detector situated at the alarm point (for example, glass breakage detector, smoke detector, and so forth) and the room number or area can be identified.

The FIG. 1 event slice associated with activity in the space being monitored (that is, a snapshot in time of a condition monitored at the graphical user interface), can be interpreted in the following manner:

a) The latch condition 110 represents a door sensor that has recently been in alarm and is now out of alarm;

b) The latch condition 112 represents a motion detector that was recently in alarm and is now out of alarm;

c) The latch conditions 114, 120, and 122 represent motion detectors in the same state as latch condition 112; these conditions inform the user of two separate tracks (i.e., paths) of an intruder;

d) The point 116 is in alarm. By positioning the mouse cursor at that point, the user can determine that the point is, for this example, a motion detector. The point 124 is also in alarm. By positioning the mouse cursor at that point, the user can determine that the point is, for this example, a door contact sensor, indicating an open door.

e) The points 126, 130, 134, 136, 138 represent smoke detectors that are in the alarm state. The environmental sensor (temperature) 128 is in a rate-of-rise alarm indicating the temperature in that room has exceeded a predefined rate of temperature increase that is indicative of a fire. The environmental sensor (temperature) 132 is at a value higher than the observed average of the majority of the sensors.

An analysis summary can be displayed to indicate that an intrusion occurred at the front door and that there are at least two intruders, one going left into a front room and up the hall and exiting the building at 124. A second intruder has moved right down the hall. The display indicates that the second intruder is still in the building near detector 116. The data further indicates that one of the intruders started a fire before exiting the building. The smoke detectors 126, 130, 134, 136, and 138 are in alarm indicating the extent of the smoke plume. Further examination shows that an environmental sensor (temperature) 128 within the plume has signaled a rate-of-rise alarm indicating the exact location within the smoke plume of the source of the fire. The environmental sensor (temperature) 132 is showing an elevated reading but has not reached an alarm state. This can be interpreted as an early warning that the fire is about to or has just broken through in that space. A LOGS menu choice 140 can be selected to review details of all time event data for each alarm point including, for example, the exact times for the break-in and the time frame of the intrusion for use by the user and/or law enforcement.

Real-time or substantially real-time updates to the FIG. 1 display can be continuously received by the supervisory monitoring system over a communication network, such as an Internet/Ethernet communication network, for the purpose of subsequent tracking. The supervisory monitoring system can include a host computer that acts as the principal monitoring station for any number of fire or other alarm panels located in one or more distinct spaces being monitored. Remote monitoring stations, fixed and mobile, can also be linked into the system from authorized police, fire, private security and other monitoring departments or agencies.

Intrusion detection, tracking and subject location are accomplished in accordance with exemplary embodiments of the present invention using known sensor technologies in conjunction with a novel notification process. For example, the alarm point state conditions can be categorized into six different states:

(1) A point currently in an alarm state;

(2) A point currently in an alarm state, and acknowledged by a monitor;

(3) A point recently in an alarm state, but unacknowledged as a current alarm;

(4) A point not in an alarm state;

(5) A point that has been disabled; and

(6) A Non-Reporting Point.

The last two states, disabled and non-reporting (or fail), represent inoperable point conditions. The remaining four active point conditions provide the monitoring operator with specific information on which points are actively set into alarm, their simultaneity (multiple points of intrusion), and which alarms have been recently in a state of alarm but which are not currently in alarm. Each of the point conditions is represented on the screen display by a unique icon, combining shape and color for easy recognition.

Inoperable point conditions appear unobtrusive. They do not distract the operator from real-time alarms, but send a clear notification that these points are not contributing to the security monitoring process. When a point alarm is acknowledged by the supervisory monitoring station, the icon for that alarm point can be changed to appear less alerting (for example, change from a first color (such as, red) to a second color (such as, yellow)), allowing the operator to focus on new activity rather than the door that had been left open. The non-alarming point icon appears clearly visible, but not disturbing in color and shape. An icon that is alarming in color and shape represents the alarming point (unacknowledged).

While increasing the level of information displayed on the screen, the icons act as easily discernible symbols without cluttering the screen and confusing the operator. The increased level of information displayed provides the operator tools to recognize the presence of multiple intruders, the ability to discern a falsely-triggered alarm (isolated alarming sensor) from a legitimate alarm, and the visual “tracking” of their activity. The monitoring authority (user) can then apply pattern analysis to real-time changes in alarm states to discriminate between false and genuine alarms, and to track movement of an intruder or spread of a fire.

Generally speaking, a hierarchical approach can be used to locate alarm conditions among plural spaces (for example, different buildings) being monitored. For example, a high level display can include a large geographical area, and can include indications of all facilities being monitored. Where any alarm in a given facility is tripped, the user can be notified in the high level display. By moving the cursor to that facility and clicking, a detailed floorplan such as that shown in FIG. 1 can be provided to the user.

A supervisory monitoring system of an embodiment of the present invention can display an indication at the monitoring site's screen display within, for example, 1-4 seconds from the time a sensor located at the space being monitored is tripped into an alarm condition. A mouse click on the icon representing the facility in alarm directs the system to retrieve, for the screen display, a floor plan schematic (such as that of FIG. 1) from the actual facility's security/fire panel computer that displays all alarm points included in the facility and their current states. Subsequent changes in alarm point conditions are typically displayed in 1-4 seconds from the time an alarm is triggered in the facility.

Upon confirmation of activity, the monitoring authority can contact local law enforcement or other agencies that then direct an emergency response by hyperlinking to this same building visualization of alarm conditions using, for example, a remote monitoring station located at the police/fire or other dispatch center. Responding personnel at the scene can also access this visual display of alarm conditions by linking to that facility's security/fire panel through a remote monitoring station in the emergency vehicle using a wireless hub. By clicking on a MAP icon 142, for example, maps showing directions to the facility, or any other maps (such as complete floor plans of the facility) can be displayed.

In its fire monitoring role, a system of an embodiment of the present invention can use the same communication protocols to spawn real-time updates of changes in fire alarm points that are displayed visually on a monitoring site's display screen. Again, the visual display can be a building floor plan overlaid with icons detailing all fire alarm point sensors. Pattern analysis can be used to discriminate a genuine alarm from a false one and to track the spread of a real fire. In addition the color of the icon representing the fire alarm point could indicate a normal not-in-alarm state, an intermediate state representative of a abnormal or early warning state (sensor change detected but below alarm state) and one or more alarm states defined by a controlling algorithm. Like police, firefighters at the scene can access the visual display of alarm conditions through a remote monitoring station in the emergency vehicle using a wireless hub.

Thus, embodiments of the present invention can provide electronic security and fire alarm protection which permits real emergencies to be distinguished, and which provides law enforcement and fire fighters with real-time or substantially real-time on-the-scene information for arrest-in-progress and/or effective fire fighting. Communication programs may also be used so that real-time or substantially real-time conditions of security and/or fire alarm points in a remote protected facility can be displayed on a central supervisory monitoring station's display and/or on remote monitoring stations.

In embodiments, on-the-scene wireless connectivity can also be used by responding police/fire response units where these units connect into the live visualization to track the intruder(s) or fight the fire. In security, fire, and any other monitoring, embedded maps accessed via the MAPS icon 142 assist in getting response units quickly to the scene. Once on the scene, police officers, firefighters, or other response personnel can access the visualization of alarm activity through a wireless interface of a remote monitoring station residing on a laptop computer and the building's security/fire panel containing an embedded communication program. In accordance with exemplary embodiments, a specialized communication protocol combines a conventional wireless protocol, such as the 802.11 wireless protocol, with communication programs.

Exemplary embodiments can provide interactive reporting of facility security information between four basic subsystems over an Internet/Ethernet communications link. The four subsystems are:

(1) Security/Fire Panel

This subsystem directly monitors the status of individual sensors and reports their state to the requesting host, remote and mobile computer subsystems. Embedded data sets can be used to provide host, remote and mobile users detailed information on the site.

(2) Host Computer

This subsystem, through a communications interface, provides a real-time display of a regional map depicting the location of all the sites within a security network and their status. Other remote subsystems used to remotely monitor the sites can gain access to the security/fire panel at each site through the host computer display page. A local graphic interface provides the host computer operator access to the same detailed information. Communications programs operating within the host maintain real-time status of the sites/alarm points and continually update the display screen.

(3) Remote Computer

This subsystem accesses the communication program within the host computer which displays a map of the area sites and their current status. Using a mouse, a site can be selected to view the details of its status. Upon selection, the remote subsystem can be directly connected via a hyperlink to an embedded communication program within the security/fire panel. Similar to the host computer, the screen updates of site and point status is maintained through a communications program.

(4) Mobile Computer

The mobile computer can gain connectivity to the ethernet network local to the security/fire panel through a wireless LAN, once it is within the operating range. “Broadcast packets” (for example, encrypted packets which can be decrypted by the mobile computer) can be sent by the security/fire panel and be used to instruct the mobile computer how to directly access the security/fire panel's communication interface through a monitoring station program. Once connected to the security/fire panel, the mobile computer interface can operate like the remote computer.

General Communications Overview

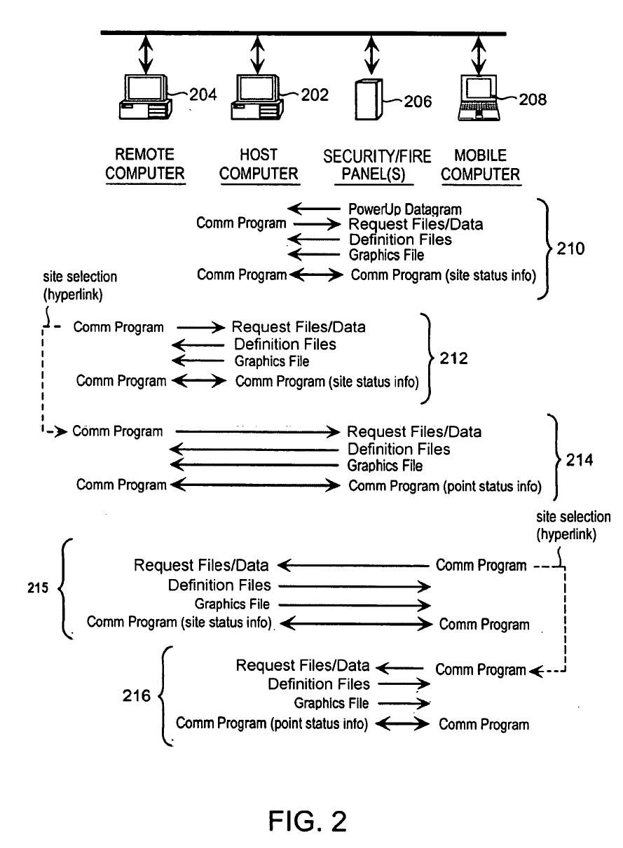

Communications between the various subsystems of embodiments of the present invention are disclosed in FIG. 2. Standard network communication tools may be combined with unique graphics and communication programs to effect real-time performance through minimal bandwidth.

FIG. 2 provides a general overview of the communications that transpire between the four basic subsystems of embodiments of the present invention; that is, (1) a host computer 202; (2) a remote computer 204; (3) security/fire panel(s) 206; and (4) mobile computer 208. Communications between the host computer 202 and the security/fire panel(s) are represented as communications 210, with arrows indicating the direction of information flow. For example, following a powerup indication from the security/fire panel, and a connection by the host's local communication program to the security/fire panel's embedded communication program, files regarding site information (such as floorplan) and alarm status information can be sent to the host. Similar protocols can be followed with respect to communications between the remaining subsystems. Communications between the host computer 202 and the remote computer 204 are represented as communications 212. Direct communications between the remote computer 204 and the security/fire panel(s) 206 are represented as communications 214. Communications between the host computer 202 and the mobile computer 204 are represented as communications 215. Finally, direct communications between the security/fire panel and the mobile computer are represented as communications 216.

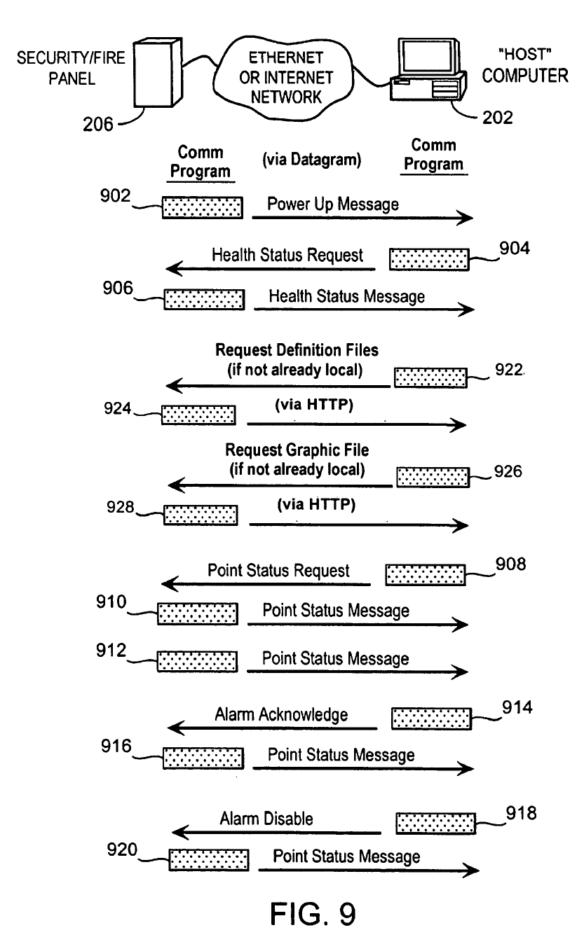

Those skilled in the art will appreciate that the information flow represented by the various communications paths illustrated in FIG. 2 are by way of example only, and that communications from any one or more of the four basic subsystems shown in FIG. 2 can be provided with respect to any other one of the four basic groups shown, in any manner desired by the user. More detailed discussions of the specific communication paths in accordance with the exemplary embodiment illustrated in FIG. 2 will be described with respect to FIGS. 9-12. However, for a general understanding of the basic communications, a brief overview will be provided with respect to FIG. 2.

As illustrated in FIG. 2, most inter-subsystem communications are initiated by executing a communication program in accordance with an exemplary embodiment that is represented in FIG. 2 as an “Comm Program.” When the monitoring program is directed to a specific site address (both the host computer and the security/fire panel are assigned Internet protocol (IP) addresses), the monitoring software attempts to connect to a port at the IP address. The communication program at the addressed site recognizes the connect request at the port as a request to transfer the site information (contained, for example, in a definition data files). Once the site information is transferred, the software begins to process the instructions within the definition data files. Within the file are references to a graphics file to be displayed. If these files are not locally available, the communication software requests the transfer of the files from a host, using a hypertext transfer protocol (HTTP). Once received (and locally saved), the monitoring software displays and executes the files as directed by the definition data file.

In an embodiment, the graphics files displayed serve as the bitmap background that the site and point status icons are written on, serving as visual status indicators to the monitoring operator. The communications program performs the real-time communications between the subsystems and an application program performs the painting of the status icons. When the communications reveal a change in point or site status, the screen icons are repainted to reflect the new conditions. These communication programs enable real-time performance over conventional communications networks such as the Internet.

3. System Overview

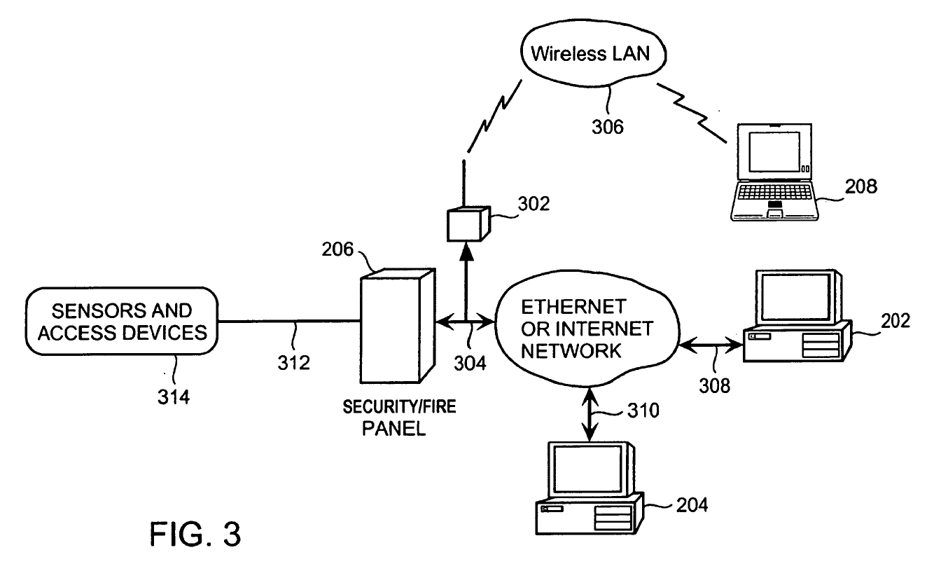

FIG. 3 depicts a general system block diagram of an exemplary fire alarm monitoring system according to the present invention, comprised of the security/fire panel 206, the host computer 202, the remote computer 204, the mobile computer 208, and an optional wireless LAN hub 302. The security/fire panel is installed within the space (that is, the physical facility) being monitored, and is permanently connected to an Internet or Ethernet network 304. The wireless hub 302 can be installed at the facility site to provide connectivity for the mobile computer 208 via a wireless LAN 306. The host computer 202 can be installed anywhere so long as it is connected to the same Internet or Ethernet network 308 to which the security/fire panel is attached. The remote computer 204 can be installed anywhere so long as it can access the same Internet or Ethernet network 310 to which the host computer and the security/fire panel are attached (permanent, dial-up, and so forth). The mobile computer 208 is within the coverage area of the wireless LAN hub to access the security/fire panel over the wireless LAN 306.

As depicted in FIG. 3, the security/fire panel 206 monitors the status of sensors 314 installed within the monitored facility via data links 312. When an enabled sensor changes state, a POINT STATUS message is sent to the host computer 202. The host computer, usually monitored by an operator, repaints the icons shown on its display screen to reflect the updated condition of the security/fire panel. Any mobile computer or remote computer currently connected to the security/fire panel reporting the changed point condition can also repaint the icons on their own display after the next status query response.

a. Host Computer

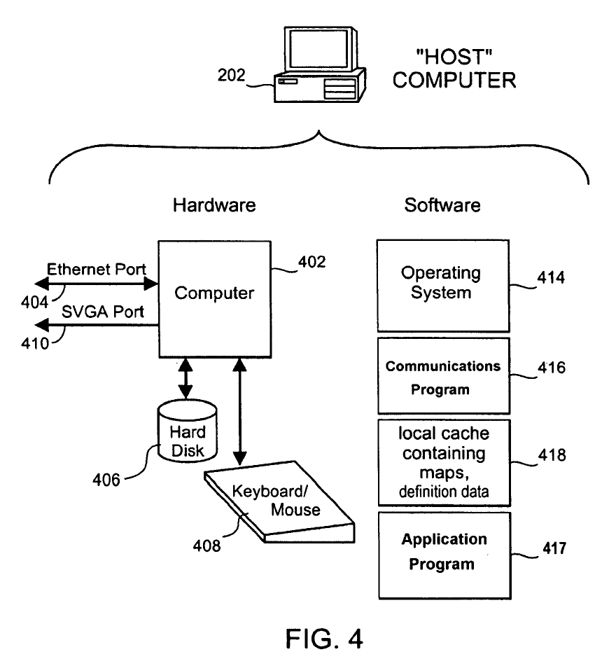

FIG. 4 depicts hardware and software components of an exemplary host computer 202. The CPU motherboard 402 for example, (e.g., based on Intel processor or any other processor) is a conventional personal computer that will support any desired network operating system 414, such as any 32-bit operating system including, but not limited to the Microsoft XP Operating System. An exemplary motherboard will feature, or accommodate, Ethernet communications port 404 for interfacing with an Internet or Ethernet network. A hard disk 406 can be installed to support information storage. A keyboard and mouse 408 can be attached for operator interface. A display, such as an SVGA monitor can be attached via an analog or digital video graphics applications port 410 for a visual display unit. The Operating System 414 can be installed in a standard manner, along with the network communication software package 416. An application program 417 is installed. A local cache directory 418 is installed with supporting graphic files (i.e. regional maps), local definition data files, and any other desired information.

b. Remote Computer

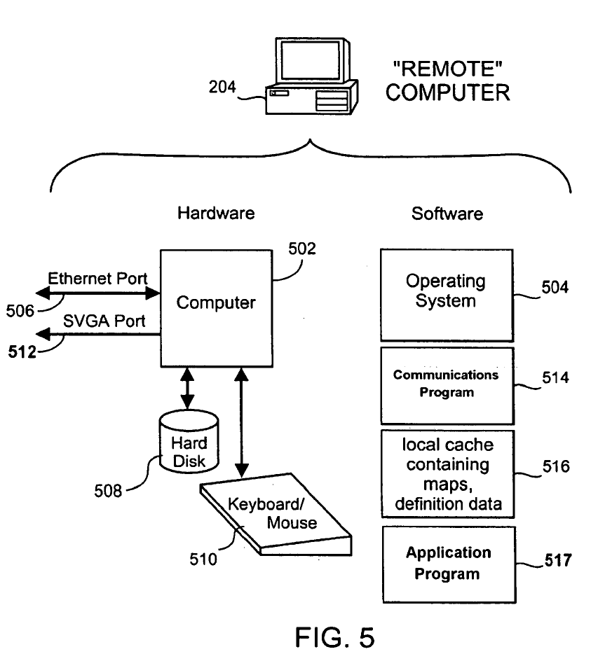

FIG. 5 depicts hardware and software components of the exemplary remote computer 204. The CPU motherboard 502 (e.g., based on Intel processor or any other processor) is a conventional personal computer that will support the desired network operating system 504, such as any 32-bit operating system, including but not limited to the Microsoft XP Operating System. The motherboard will feature, or accommodate Ethernet communications 506 with an Internet or Ethernet network via Ethernet port 506. A hard disk 508 will support information storage. A keyboard and mouse 510 will provide operator interface. An SVGA monitor can be attached via port 512 for a visual display unit. The operating system 504 is installed in a standard manner, along with a communication software package 514. An application program 517 is installed. A local cache directory 516 is installed with supporting graphic files (for example, individual room layouts, floorplans, side view of multi-story facility, and so forth), local definition data files, and other local data files.

c. Security/Fire Panel

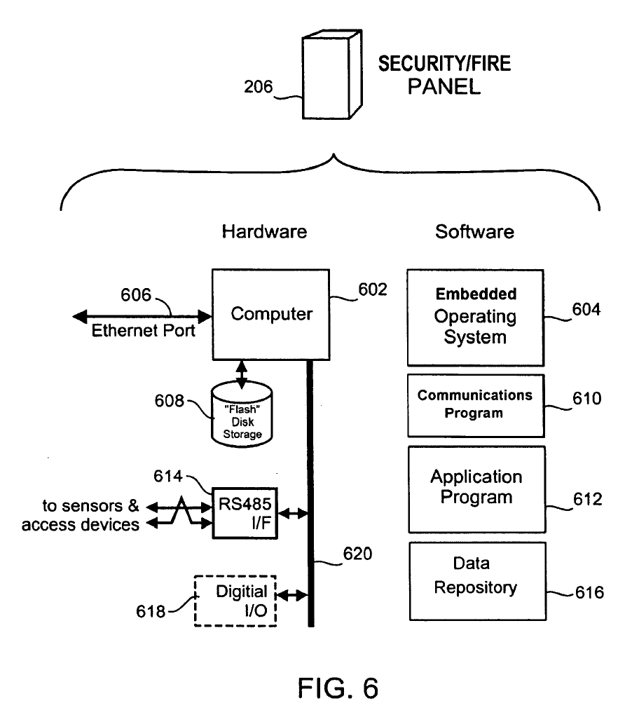

FIG. 6 depicts hardware and software components of the exemplary security/fire panel 207. The CPU motherboard 602 (e.g., based on Intel processor or any other processor) is an embedded computer that will support the desired network operating system 604 such as any embedded 32-bit operating system including, but not limited to the Microsoft embedded XP operating system. The motherboard will feature, or accommodate Ethernet communications with an Internet or Ethernet network via Ethernet port 606. A “flash” disk 608 will support information storage. The operating system can be installed in a standard manner. A communication program 610 is installed. A main application program 612 is also installed, including local data files, and the primary data repository 616 for all graphics and definition files related to the site monitored by this Panel. Communications protocols, such as RS485 communications protocols 614, are supported to facilitate communications with the sensors, sensor controller and other access devices. As supporting inputs, direct digital I/O boards 618 can be added to the local bus 620.

d. Mobile Computer

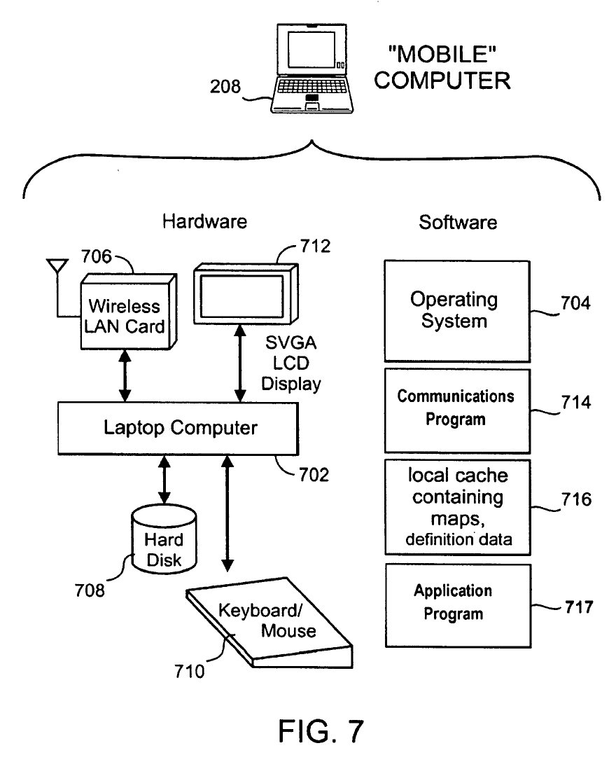

FIG. 7 depicts the hardware and software components of the exemplary mobile computer 208. The CPU motherboard 702 (e.g., based on Intel processor or any other processor) is a conventional laptop computer or other mobile computing platform that will support the desired network operating system 704, such as any 32-bit operating system including, but not limited to the Microsoft XP Operating System. Add-on boards can be installed to interoperate with, for example, IEEE 802.11 Ethernet communications 706, compatible with the installed wireless hub 302 (shown in FIG. 3, for example). A hard disk 708 is installed to support information storage. An integral keyboard and mouse 710 are attached for operator interface. A display, such as an SVGA LCD monitor 712 is attached for a visual display unit. The operating system can be installed in a standard manner, along with a communications software package 714 and application software package 717. A local cache directory 716 is installed with supporting graphic files (i.e. individual room layouts, floorplans, side view of multi-story facility, and so forth), local definition data files, and other local data files.

e. Screen Display

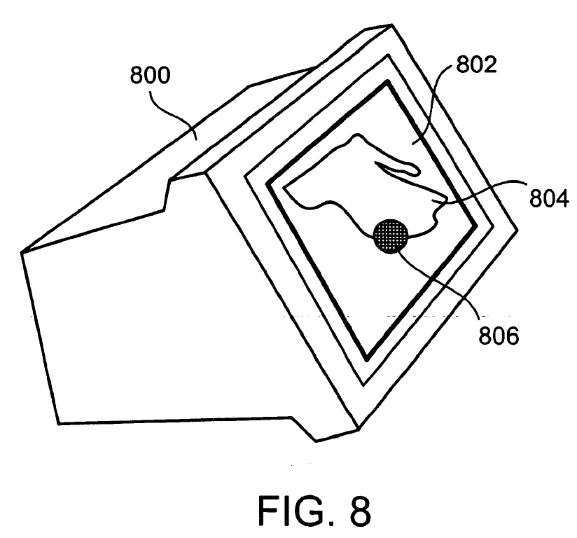

FIG. 8 depicts screen display graphic components of the embodiments of the present invention. These components are common to the screens available to the host computer, remote computer and mobile computer users. These display components are made available through, for example, the use of a communications interface, using graphics data and real-time communications programs. When the communication software initializes, it generates the window frame 802 on the display 800. When the program addresses the communications interface within the host computer or a security/fire panel, definition data files are transferred. Within the definition data files is a reference to a graphic image file 804 to be displayed. This file represents, for example, a regional map, the facility floorplan, or an individual room layout. Also referenced in the definition data files is the communications program 806.

The communications software queries and monitors the condition of the panel/point status of the remote sites. Upon initialization, and as new status is received, the communications program “paints” new icons 806 atop the graphics display, the icons representing the location and status of the depicted site/point.

In an exemplary embodiment, there are six states represented by the icons; (1) ALARM (point/site in alarm but not acknowledged), (2) ACKNOWLEDGED (ACK'D) ALARM (point/site in alarm and acknowledged by security monitor), (3) RECENT ALARM (point/site recently in alarm), (4) NORMAL (point/site not in alarm), (5) DISABLED (point/site disabled) and (6) FAIL (point/site not responding). These different states allow the monitoring user to determine the current and recent location of an intrusion or other event, provide the visualization of multiple points of intrusion or other event, and the ability to visually discriminate between legitimate and falsely-triggered alarms. All communications among the networked components may be transferred using standardized network protocol data packets.

In an additional embodiment, three additional icons may be provided: (1) HIGH ALARM, indicating a high alarm state, (2) a LOW ALARM, indicating a low alarm state and (3) a RATE OF CHANGE ALARM STATE. These alarm states are described below.

In another embodiment, the value of an environmental or other parameter (such as temperature) of a sensor throughout a space may be graphically depicted displaying the actual digital parameter. Wherein the color of that icon represents the state of the alarm, i.e., a HIGH ALARM, a LOW ALARM, an EARLY WARNING ALARM, a RATE OF CHANGE ALARM or a NON ALARM STATE.

In another embodiment, the color of the icon for each sprinkler control valve located throughout a space depicts the current state of that valve (OPEN, RECENTLY OPEN or CLOSED). In another embodiment, the value of state of a control parameter such as sprinkler system shut-off valve (OPEN, RECENTLY OPEN or CLOSED) is depicted. This embodiment is described below.

4. System Communications

a. Security/Fire Panel-Host Communications

FIG. 9 depicts the communications between the exemplary security/fire panel 206 and the exemplary host computer 202. Upon the application of power, the security/fire panel sends a PowerUp Message 902 to its designated host computer IP address. On regular intervals, the host computer sends a HEALTH STATUS REQUEST 904 datagram to each security/fire panel. A repeated failure to receive a response packet 906 indicates to the host computer that the panel communications link has failed and its icon is updated. When received by the host computer, this message is logged into a local data file. When initially engaging communications with the security/fire panel, the host communication software requests and downloads the data files 922 that define the security/fire panel display page(s) 924. The data file includes the reference to a graphics file. If the current version of the file does not exist locally, the host computer communication software makes a request 926 for the HTTP transfer of the graphics data file from the panel. Once received from the panel in transfer 928, the graphics data file is locally stored (in cache directory) and is displayed on the display screen. Once the required data is determined to be located on the host computer, the host computer sends a POINT STATUS REQUEST 908 to the security/fire panel. Until an initial status has been determined, all icons are represented with an UNKNOWN icon (such as a circle with “?”). If the request repeatedly goes unanswered, the site is determined to be inoperative and is represented with a FAIL icon.

The successful receipt of the POINT STATUS response packet 910 causes the host computer to repaint the screen icons to represent their current determined condition. When a point status has changed, the security/fire panel sends a POINT STATUS message 912 to its designated host computer IP address. Upon its receipt, the host computer repaints the icons to represent the current status. In another embodiment, the host computer repaints the screen or other depiction of the space to represent the states or values of an environmental or other parameter throughout the space.

When a monitoring operator at the host computer wants to acknowledge an annunciated alarm condition, an ALARM ACK packet 914 is sent to the security/fire panel, along with a reference to the alarm being acknowledged. When received by the security/fire panel, the condition of the point is updated and a new POINT STATUS message 916 is sent back to the host computer. Again, the receipt of this packet causes the host computer to repaint the icons on the screen. If the monitoring operator wants to disable a point, group of points, or an entire site, an ALARM DISABLE message 918 is sent (containing a mask reference for the point array). When received by the security/fire panel, the point condition(s) is (are) modified and a new POINT STATUS message 920 is sent in response. Its receipt by the host computer repaints the icons, updates the value of the parameter or other depictions of the space on the screen display.

b. Remote Computer-Host Computer Communications

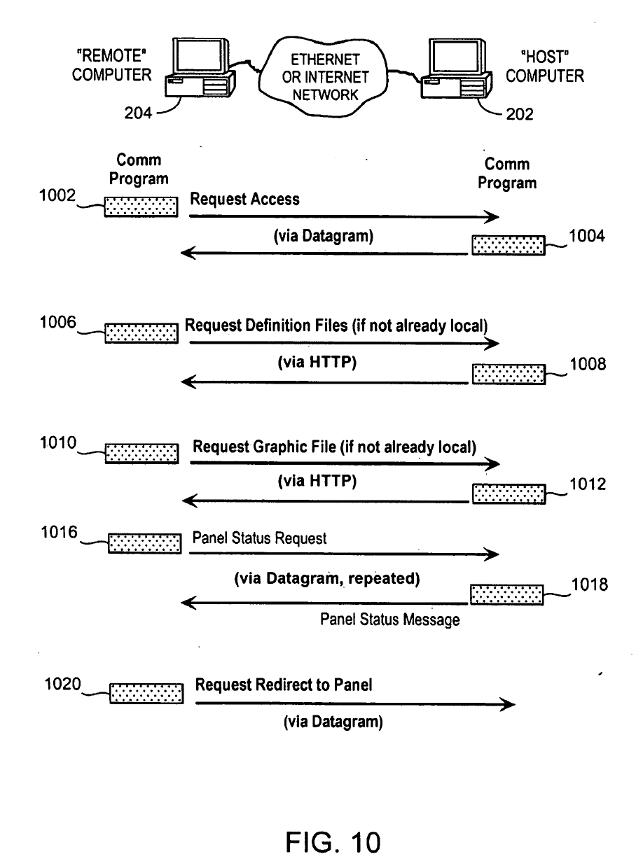

FIG. 10 depicts communications between the exemplary remote computer 204 and the exemplary host computer 202. When the remote computer user wishes to attach to the security system, it executes a communication software package and connects to the Internet or Ethernet network (e.g., Internet Service Provider (ISP) dial-up, local hardwire, and so forth). When actively connected, the user directs the communication program to the IP address of the host computer, seeking to connect to the host computer's communication program 1002. The host computer 202 signals the remote computer 204 that access is permitted or denied 1004.

When successfully accessed, the communication software requests and downloads the data files 1006 that define the host and/or security/fire panel display page(s) 1008. The data file includes the reference to a graphics file. If the current version of the file does not exist locally, the remote computer communication software makes a request 1010 for the HTTP transfer of the graphics data file from the host computer. Once received from the host computer in transfer 1012, the graphics data file is locally stored (in cache directory) and is displayed on the display screen.

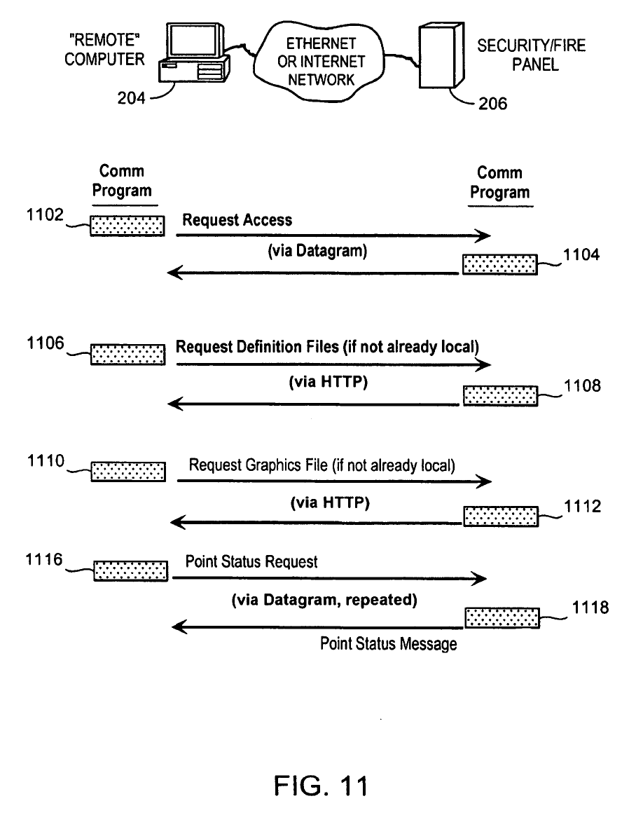

Once the required data is determined to be located on the remote computer, the communications program begins a continuous polling sequence, requesting the status of the various panel sites via requests 1016. When the communications program receives the response status messages 1018, all the icons overlaying the graphics screen are repainted to indicate the current status of the sites. When the remote computer user selects the icon of a site for more detail, the communications software can immediately connect to the IP address of the selected security/fire panel (connecting to the embedded web server within the panel in step 1020), and perform communications as described in FIG. 11.

c. Remote Computer-Security/Fire Panel Communications

FIG. 11 depicts the communications between the exemplary remote computer 204 and the exemplary security/fire panel 206. The remote computer gains access to the security/fire panel through the host computer via reference to an IP connection. When selected, the communication program is directed to the IP address of the security/fire panel, seeking to connect to the security/fire panel's embedded communications program 1102. When access is allowed 1104, the remote computer requests 1106 that the embedded communication program download the definition data files 1108 that define the security/fire panel's display page. The definition data files include a reference to a graphics file. If the current version of the file does not locally exist, the remote computer requests the HTTP transfer of the graphics file 1110 from the security/fire panel. Once received from the security/fire panel in response 1112, the graphics file is locally stored (in cache directory) and is displayed.

Once the required data is determined to be located on the remote computer, the communications program begins a continuous polling sequence, requesting the status of the various points via a status request 1116. When the communications program receives the response status messages 1118, all the icons overlaying the graphics screen are repainted to indicate the current status of the points.

d. Mobile-Security/Fire Panel Communications

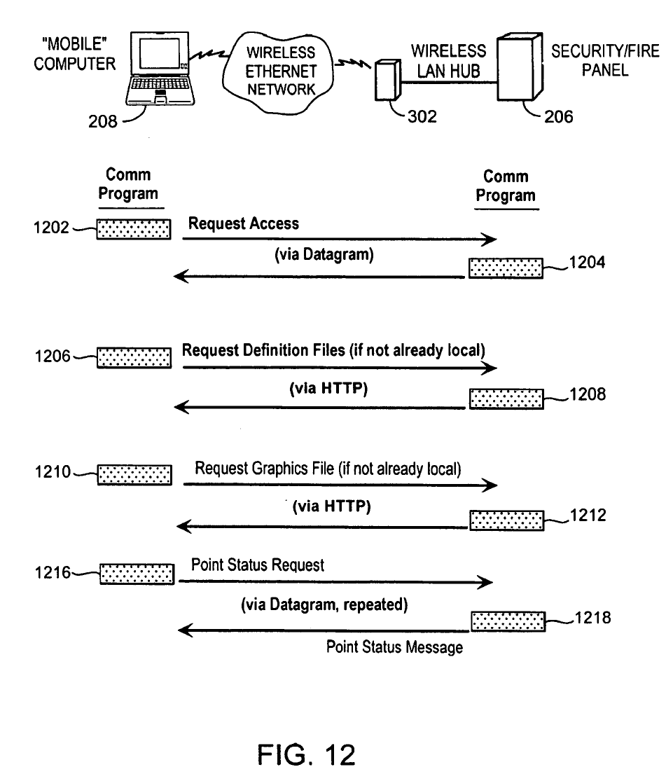

FIG. 12 depicts communications between the exemplary mobile computer 208 and the exemplary security/fire panel 207. The mobile computer 208 may gain access to the security/fire panel through a wireless local area network, enabled by the wireless LAN hub 302 and/or any available wireless network including, but not limited to existing cellular telephone networks. The mobile computer communication software is executed and seeks to connect to the security/fire panel's embedded communications program 1202. When access is allowed 1204, the remote computer requests 1206 that the embedded communication program download the definition data files 1208 that define the security/fire panel's display page. The definition data files include a reference to a graphics file. If the current version of the file does not locally exist, the remote computer requests the HTTP transfer of the graphics file 1210 from the security/fire panel. Once received from the security/fire panel in response 1212, the graphics file is locally stored (in cache directory) and is displayed. Once the required data is determined to be located on the remote computer, the communications program begins a continuous polling sequence, requesting the status of the various points via a status request 1216. When the communications program receives the response status messages 1218, all the icons overlaying the graphics screen are repainted to indicate the current status of the points.

In another embodiment of the present invention, sensors are provided at various locations in the space that is to be monitored. These sensors are able to provide real-time or substantially real-time monitoring of an environmental or other parameter and provide signals indicating a value of the parameter. Each sensor is in communication with one or more security/fire panels, as described above. In embodiments of the present invention, the security/fire panel monitors the status of the various sensors, for example, by polling the sensors at regular time intervals, such as 1.5 seconds, or other intervals appropriate to the space and parameter being monitored.

In an embodiment of the present invention, the security/fire panel is in communication with a supervisory monitoring system, which, as described above, can include a host computer configured with an communication program. The supervisory monitoring system is provided with a visual display to graphically represent the status of the various sensors. For example, in the case of temperature sensors, the visual display of the supervisory monitoring system may represent numerically the latest reported temperature at each of the temperature sensors. In the case of a sprinkler control valve, the visual display of the supervisory monitoring system may represent the latest state of the valve (OPEN, RECENTLY OPEN or CLOSED) at each sprinkler control valve. In addition, various alarm states, as described below, may be represented, such as by differently colored icons or by other representations as discussed below and as apparent to one of skill in the art in view of this specification.

In an embodiment of the present invention, the security/fire panel is programmed to contain one or more predetermined values indicative of at least one of the following: a high-end threshold, a low-end threshold, a early warning threshold and a rate-of-change threshold. In the case of a security/fire panel that is programmed with a high-end threshold, the security/fire panel will monitor the status of the sensors and if the value of the parameter measured by the sensor exceeds a predetermined high-end threshold, the security/fire panel will interpret that state as a high-end alarm. The security/fire panel will then provide a real-time or substantially real-time self-initiated notification signal to a monitoring system indicating the sensor that is in the high-end alarm state. The monitoring station may then provide a graphical representation of the sensor in the high-end alarm state, such as by use of a particular colored icon representing the sensor in high-end alarm state.

Similarly, a security/fire panel may be programmed with a predetermined low-end threshold. If the value of the parameter measured by the sensor is less than the low-end threshold, then the security/fire panel will interpret that as a low-end alarm state, and provide a real-time, or substantially real-time, self initiated notification signal to the monitoring system indicating that the sensor has entered a low-end alarm state. As with the high-end alarm state, this may be graphically represented on a visual display of the monitoring system, such as by a colored icon.

The security/fire panel may be programmed with a predetermined rate-of-change threshold. A rate-of-change threshold is a predetermined amount which the parameter may change in a specified period of time. For example, in the context of temperature sensors, the rate of change threshold may be 5 degrees in 5 minutes. Thus, the security/fire panel will monitor the measurements by the sensor over a period of time. If the rate at which the measured parameter is changing exceeds the rate-of-change threshold, then the security/fire panel will interpret this as a rate-of-change alarm state, and provide a real-time, or substantially real-time, self initiated notification signal to the monitoring system indicating that the sensor has entered the rate-of-change alarm state. This may be graphically represented on a visual display of the monitoring system, such as by a colored icon.

In another embodiment of the present invention, a plurality of sensors are located at various predetermined monitoring locations of a space to be monitored. As described above, these sensors monitor an environmental or other parameter and provide signals indicating the value of the parameter to a security/fire panel. As the state of the sensor changes in response to changes in the value of the parameter being measured, the security/fire panel will provide self-initiated real-time or substantially real time notification signals to a monitoring system indicating the new state of the sensor. In an embodiment, the security/fire panel will only provide the real-time or substantially real-time self-initiated notification signal in the event of a change in the sensor that exceeds a predetermined value. For example, in the case of temperature sensors, the security/fire panel may be programmed only to provide a notification signal if the change in temperature is greater than 1 degree F. In another embodiment, the security/fire panel may be programmed to provide a notification signal after a predetermined period of time, or at predetermined intervals after an initial notification signal triggered by a high-end, low-end, rate-of-change or other alarm.

In such embodiments, the monitoring system is provided with a visual display that represents the space being monitored with sensor control valves. In diagrams such as floorplan diagrams, different colors or shadings of the icons may be used to represent different values of a parameter. A parameter measurement as determined by a sensor may also be displayed digitally and/or through display of different colors, shadings, and other variations of a corresponding icon.

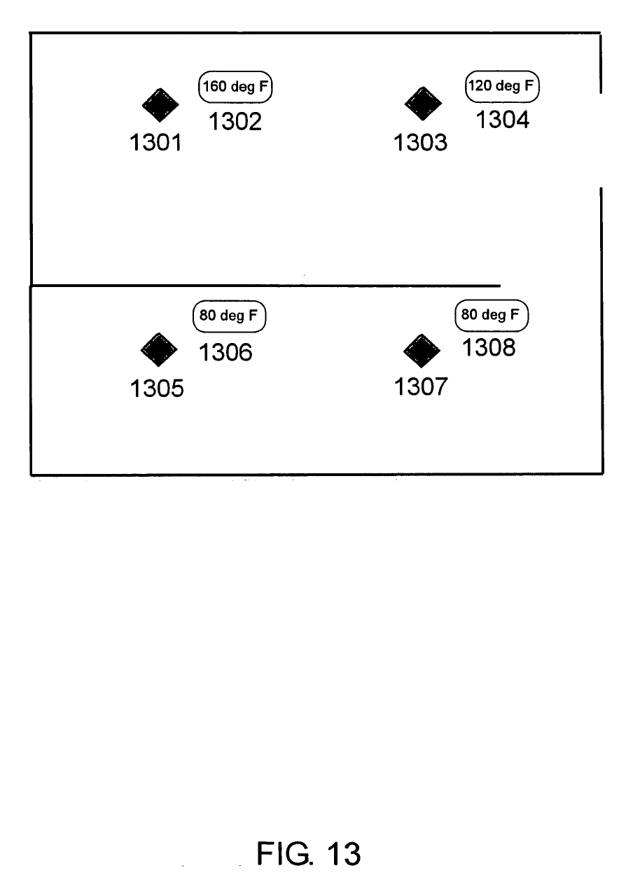

As an example of an embodiment of the present invention providing a sprinkler control valve, a system in which the state of the valve is monitored will now be described. However, it would be understood by one skilled in the art that this is by way of example only and that other environmental or other parameters may be used, such as those described above or others that are known in the art or apparent in view of this specification. In this example, the four sprinkler control valves 1301, 1303, 1305, and 1307 in a space are being controlled by four separate temperature sensors, 1302, 1304, 1306 and 1308. This arrangement is depicted in FIG. 13. The measured temperature at the temperature sensors are 160° F., for sensor 1302, 120° F. for sensor 1304, 80° F. for sensor 1306, and 80° F. for sensor 1308. These temperatures can be used to determine whether the sprinkler control valve is on or off and may be represented by using a particular color or shadings corresponding to a HIGH ALARM STATE, LOW ALARM STATE, EARLY WARNING STATE, RATE OF CHANGE ALARM STATE or a NON ALARM STATE. Further the color icon representing the sprinkler control valve indicates whether the sprinkler control valve is OPEN, RECENTLY OPEN or CLOSED. The information content displayed in this embodiment may be utilized by a predefined control algorithm to initiate the OPEN, RECENTLY OPEN or CLOSED state of the sprinkler control valve or be controlled manually by an operator monitoring the emergency.

A state of the fire suppression system for the entire space can be derived by using the information derived from sensors 1301 through 1308. For example, sensor 1302 depicts a fire with recorded temperature of 160° F. The HIGH ALARM or RATE OF RISE state of this sensor indicates that an active fire is present which would initiate fire suppression automatically thus changing the state of sensor 1301 from OFF to ON. The sensor located at 1304 reads 140° F. which is representative of the LOW ALARM or PRE ALARM state where the sprinkler control valve may be opened via an operator initiated open command. In this case the sprinkler control state would remain OFF until the command to open is issued by the operator. The sensors located at 1306 and 1308 indicate no active fire, and thus no fire suppression activity is indicated at sprinkler control valves 1305 and 1307. This process may be repeated for the entire space so that a complete, or nearly complete, visual representation is provided of the state of fire suppression activity or other parameter throughout the space being monitored. Such a depiction may provide valuable information to users of the present invention. For example, such a depiction may reveal that a fire has occurred in a particular part of a building and that there are other parts of the building that may be safely entered to approach the fire.

In embodiments of the present invention, alarm information is transmitted to and displayed by a monitoring system including one or more mobile devices, such as personal computers equipped with wireless communication capabilities, used by firefighters or hazardous materials or other response personnel as they travel to the space in response to an alarm. As the sensor states change in response to parameter-value changes in the monitored space, these response personnel can receive that information in near real-time, and can develop a strategy, as they travel to the monitored space, for addressing the problem that triggered the alarm. In situations where an alarm requires responses by multiple teams—such as a large fire or chemical fire requiring fire, police, rescue and environmental teams—embodiments of the present invention provide each team with mobile monitoring capabilities displaying the same information, including changes about the alarm situation, in near real-time. These teams thus have the ability to develop a plan and coordinate their planned actions as they travel to the monitored site, thus improving the timeliness and effectiveness of their response and enhancing their own safety.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A system for monitoring a space, comprising:
a sensor configured to monitor a parameter; and
a security/fire panel located at the space and configured to:
receive information from the sensor regarding a value of the parameter;
identify a first alarm state from the parameter value information; and
initiate fire suppression in response to the alarm state.

2. The system of claim 1, wherein the first alarm state is identified when the value of the parameter exceeds either a predetermined high-end threshold or a predetermined rate-of-change threshold.

3. The system of claim 1, wherein the security/fire panel is further configured to identify a second alarm state when the value of the parameter is less than a predetermined low-end threshold.

4. The system of claim 3, wherein the security/fire panel is further configured to identify a second alarm state, and to deactivate fire suppression in response to identifying the second alarm state.

5. The system of claim 1, wherein the security/fire panel is further configured to alert an operator of an alarm state.

6. The system of claim 1, wherein the security/fire panel is further configured to alert an operator in or near the space to locally enable or disable fire suppression.

7. The system of claim 1, wherein the security/fire panel is further configured to enable an operator remote from the space to remotely enable or disable fire suppression by automatically activating or deactivating a fire suppression system.

8. The system of claim 1, wherein initiating fire suppression comprises activating a fire suppression system.

9. The system of claim 8, wherein the fire suppression system comprises a fire suppression device located near the sensor.

10. The system of claim 8, wherein the fire suppression system comprises a sprinkler control valve.

11. The system of claim 9, wherein the security/fire panel is configured to monitor a state of the sprinkler control valve.

12. The system of claim 10, further comprising a graphical user interface configured to display an icon responsive to a state of the sprinkler control valve.

13. The system of claim 8, wherein the security/fire panel is further configured to monitor a state of the fire suppression system.

14. The system of claim 8, wherein the parameter comprises at least one of a state of a sprinkler control valve of the fire suppression system and a state of a shut-off actuator of the fire suppression system.

15. The system of claim 1, further comprising a graphical user interface configured to display, in substantially real-time, an icon responsive to a state of a fire suppression shut-off valve of the fire suppression system.

16. The system of claim 1, further comprising a monitoring station remote from the space, wherein the security/fire panel is configured to automatically transmit alarm information to the remote monitoring station in response to the first alarm state.

17. The system of claim 1, further comprising a graphical user interface configured to display an icon responsive to the first alarm state.

18. The system of claim 1, further comprising a graphical user interface configured to display the value of the parameter.

19. The system of claim 1, wherein the information received from the sensor comprises a self-initiated notification signal indicating a change of the value of the parameter measured by at least one of the plurality of sensors, and wherein the information is received at substantially the same time the change is measured.

20. The system of claim 1, wherein the parameter is temperature, and the temperature is displayed digitally.

21. The system of claim 1, wherein the parameter is temperature, the temperature is displayed as an icon, and the color of the icon is responsive to the current value of the temperature.

22. The system of claim 1, wherein the act of initiating fire suppression comprises opening a sprinkler control valve located near the sensor.

23. The system of claim 1, wherein the parameter comprises at least one of a measure of signal integrity in a communication transmission facility and a bit error rate in a communication transmission facility.

24. A system for monitoring a space having a plurality of sensors, each of the plurality of sensors located at a predetermined monitoring location, comprising:
a monitoring system configured to receive a substantially real-time self-initiated notification signal indicating a change of a value of a parameter measured by at least one of the plurality of sensors; and
a graphic interface configured to display, responsive to the substantially real-time self-initiated notification signal:
the value of the parameter measured by the at least one of the plurality of sensors;
a state of fire suppression activity within an area associated with an alarm responsive to the change of the parameter value; and
a state of a fire suppression actuator of a fire suppression system in the area.

25. A system for monitoring a space, comprising:
a sensor configured to monitor a parameter; and
a security/fire panel located at the space configured to receive information about a value of the parameter from the sensor, the security/fire panel further configured to:
identify a high alarm state from the parameter value information when the value of the parameter exceeds either a predetermined high-end threshold or rate of rise threshold, and initiate fire suppression responsive to the high alarm state;
identify a low alarm state from the parameter value information when the value of the parameter is lower than a predetermined low-end threshold, and disable fire suppression responsive to the low alarm state;
alert an operator to enable or disable a fire suppression system based on identifying a high or low alarm state;
monitor the state of a fire suppression shut-off valve of the fire suppression system; and
automatically transmit high alarm state information and low alarm state information to a monitoring station.
